(19) United States
(12) Patent Application Publication
(10) Pub. No.: US 2024/0243465 A1
(43) Pub. Date: Jul. 18, 2024

(54) ANTENNA DEVICE FOR AUTOMOTIVE RADAR APPLICATIONS

(71) Applicant: HUBER+SUHNER AG, CH-9100 HERISAU (CH)

(72) Inventors: Jerzy KOWALEWSKI, St. Gallen (CH); Alejandro GARCIA TEJERO, St. Gallen (CH); Pietro ROMANO, Rorschach (CH); Michael PIEPER, Röthis (AT); Eugen WILLMANN, Arbon (CH); Mike NOTTER, St. Gallen (CH); Francesco MERLI, St. Gallen (CH); Angelo FRENI, Firenze (IT); Agnese MAZZINGHI, Firenze (IT)

(73) Assignee: HUBER+SUHNER AG, CH-9100 HERISAU (CH)

(21) Appl. No.: 18/559,748

(22) PCT Filed: May 19, 2022
(86) PCT No.: PCT/EP2022/063535

§ 371 Date: Nov. 8, 2023

(30) Foreign Application Priority Data
May 19, 2021 (CH) 00557/21

(51) Int. Cl. H01Q 1/42; G01S 7/03; G01S 13/931; H01Q 1/32

(52) U.S. Cl. CPC H01Q 1/421; G01S 7/032; H01Q 1/3233; G01S 13/931

(57) ABSTRACT

An antenna device for automotive radar applications including an antenna assembly which comprises a front face in which at least one antenna aperture is arranged, configured to receive an incoming signal in form of primary rays impacting in the at least one antenna aperture. The front face of the antenna assembly further includes adjacent to the at least one antenna aperture scattering elements by which primary rays, impacting an area of the scattering elements, are at least partially reflected by the scattering elements and thereby separated into first secondary rays and second secondary rays, such that the first secondary rays and the second secondary rays cancel out each other at least partially by interference.

### BACKGROUND OF THE INVENTION

### Field of the Invention

The present disclosure relates to an antenna device for automotive radar applications.

### Discussion of Related Art

From the prior art several radiating elements are known e.g., from EP 2676327 B1, WO 2017167916 A1, WO 2017158020 A1, WO 2018001921 A1 of the same applicant.

US 20170271776 A1 by Commscope published in 2017 shows a panel array antenna comprising an input layer including a waveguide network coupling an input feed on a first side thereof to a plurality of primary coupling cavities on a second side thereof, and an output layer on the second side of the input layer. The output layer includes an array of horn radiators, respective horn radiator inlet ports in communication with the horn radiators, and respective slot-shaped output ports in communication with the respective horn radiator inlet ports to couple the horn radiators to the primary coupling cavities.

U.S. Pat. No. 9,692,117 B2 by Nec Corp. published in 2017 shows an antenna including an antenna layer, a coupling layer and a feeder circuit layer. The antenna layer includes horn antennas which are arranged in such a manner that the centers thereof are aligned in a direction and in that the horn antenna is separated from the horn antenna in a direction and centers of the horn antennas are not aligned in the direction and a waveguide is formed in the coupling layer.

US 20200365976 A1 by Waymo published in 2019 shows an antenna including a plurality of waveguide antenna elements arranged in a first array configured to operate with a first polarization. The antenna also includes a plurality of waveguide output ports arranged in a second array configured to operate with a second polarization. The second polarization is different from the first polarization. The antenna further includes a polarization-modification layer with channels defined therein, wherein the channels are oriented at a first angle with respect to the waveguide antenna elements and at a second angle with respect to the waveguide output ports configured to receive input electromagnetic waves having the first polarization and transmit output electromagnetic waves having a first intermediate polarization.

WO 2020052719 A1 by Conti Temic published in 2020 shows a radar system for detecting the surroundings of a motor vehicle having a plastics-based antenna, wherein the plastics antenna, on a front side facing a sensor- and/or vehicle-side cover, has a plurality of individual antennas for transmitting and/or receiving radar signals and the plurality of individual antennas are used for detecting objects and/or determining angles thereof, disclosing solutions by which interference waves on the surface of the antenna and/or reflections between the antenna and the sensor-side and/or vehicle-side cover are suppressed or the negative effects thereof particularly on the determination of angles are prevented or reduced.

US 20200052396 A1 by Denso Corp. published in 2018 shows an antenna device comprising a dielectric substrate, a ground plate, an antenna section and an added-function section. The dielectric substrate includes a plurality of pattern forming layers. The ground plate is formed on a first pattern forming layer among the plurality of pattern forming layers, and functions as an antenna ground surface. The antenna section is formed on a pattern forming layer different from the first pattern forming layer among the plurality of pattern forming layers, and includes one or more antenna patterns configured to function as a radiator element. The added-function section includes one or more non-feed patterns disposed on a propagation path for an acoustic wave propagating on the dielectric substrate, and causes a radiation wave to be generated using the acoustic wave, the radiation wave having a polarization different from that of radio waves transmitted and received by the antenna section.

U.S. Pat. No. 6,262,495 B1 by University of California published in 2001 shows A two dimensional periodic pattern of capacitive and inductive elements defined in the surface of a metal sheet are provided by a plurality of conductive patches each connected to a conductive back plane sheet between which an insulating dielectric is disposed. The elements act to suppress surface currents in the surface defined by them. In particular, the array forms a ground plane mesh for use in combination with an antenna. The performance of the ground plane mesh is characterized by a frequency band within which no substantial surface currents are able to propagate along the ground plane mesh. Use of such a ground plane in aircraft or other metallic vehicles thereby prevents radiation from the antenna from propagating along the metallic skin of the aircraft or vehicle. The surface also reflects electromagnetic waves without the phase shift that occurs on a normal metal surface.

U.S. Ser. No. 10/944,184 B2 by Aptiv Tech. LTD published in 2020 shows an antenna device including a substrate. A plurality of conductive members in the substrate establish a substrate integrated waveguide and a plurality of first and second slots are on an exterior surface of a first portion of the substrate. Each of the second slots is associated with a respective one of the first slots. The first and second slots are configured to establish a radiation pattern that varies across a beam of radiation emitted by the antenna device. A plurality of parasitic interruptions include slots on the exterior surface of a second portion of the substrate. The parasitic interruptions reduce ripple effects otherwise introduced by adjacent antennas.

U.S. Pat. No. 8,390,531 B2 by Nippon Telegraph and Telephone published in 2010 shows a reflect array according to the present disclosure includes a plurality of array elements forming an array configured to control a direction of a reflected wave (scattered wave) by controlling a phase of the reflected wave; and a ground plane (30). The ground plane has a structure with a frequency selective function.

### SUMMARY OF THE INVENTION

The use of millimeter-wave (MMW) frequencies for communications and automotive radar applications is continuously expanding. Antenna devices are critical components in all these applications, and come with advanced requirements in terms of performance, size, weight and compliance to environmental standards. In terms of performance, antenna gain and efficiency are crucial parameters since they directly affect the overall system link budget (translating to link distance and coverage for communication systems, and to maximum detection range for automotive radars). Usually, antenna devices for automotive radar applications are mounted behind the shell or surface layer of the bumper. In addition to the focus on antenna characteristics, the continuous search of increased overall sensor performances calls for a mitigation of the interaction of the antenna with its surroundings, such as e.g., bumpers, when mounted behind them, radome, and PCB-interference. Especially in automotive applications the radome and the bumper presence reduce the radar sensor performances, distorting the radiated and/or received pattern and/or increasing noise level and in general decreasing the accuracy of detection. Typically, the antenna device is often arranged at least partially hidden under the surface of the automotive body, e.g., such that an outer shell of a bumper is arranged in front of the antenna assembly which may affect the transmitting and/or receiving capabilities of the antenna assembly in a negative manner. Furthermore, the radome presence in particular can lead to the excitation of surfaces waves which reduces the usable part of energy for radar detection purposes and can introduces false targets.

For the reduction of noise and interference caused by multiple reflected rays between the antenna device and e.g., a bumper mounted in front of the antenna device different approaches are known. From the prior art antenna assemblies are known with dummy antennas which are absorbing excessive rays by diversion in a kind of internal wave guide structure. In this case antenna apertures are arranged at a front face of the antenna which are typically not interconnected to the electronic component but terminate within the antenna assembly such that the received rays are absorbed by the material of the antenna assembly or are absorbed by components arranged on the PCB or the electronic component. The disadvantage of the known assemblies is that dummy antennas are comparatively complex to manufacture. An alternative approach of arranging protrusions on the front face of the antenna assembly is that this solution increases the overall antenna thickness.

An antenna device for automotive radar applications according to the present disclosure usually comprises an antenna assembly configured to receive incoming rays. Depending on the application, the antenna assembly can also be configured to transmit outgoing rays and receive incoming rays. The antenna assembly comprises a front face in which at least one antenna aperture is arranged configured to receive an incoming signal in form of primary rays impacting in the area of the antenna aperture. The antenna assembly usually comprises on the inside a waveguide structure by which the at least one antenna aperture is interconnected to an electronic component and/or a printed circuit board. Depending on the design the antenna aperture arranged at the front face of the antenna assembly can be designed as a horn antenna or alternatively as a slot within the front face. An advantageous simple design can be achieved when the antenna device comprises two layers which are e.g., made of metal, metallized plastic or any at the surface conductive material and flush mounted to one another. The two layers can be made of different materials which are suitable for casting or injection molding, including electromagnetic absorbing materials. Absorbing materials can alternatively be used to avoid interference.

For the mass production of antenna assemblies based on waveguide technology typical techniques include the manufacturing of the components using stacked layers and related joining techniques to connect these layers. As surface finishing is also important at MMW, the antenna assembly is designed with accurate draft angles and radii such that a good moldability of the layers of the antenna assembly is achieved. Metallization techniques like PVD, sputtering, spraying, galvanic coating can also be used to at least partially metallize the front face of the antenna assembly and/or the at least one antenna aperture. In a preferred variation the antenna assembly is horizontally polarized, wherein the half power beam-width (HPBW) is in the range of plus/minus 15° up to plus/minus 75° in the azimuth plane (horizontal plane, respectively E-plane). In the elevation plane, the HPBW can be e.g., plus/minus 1° to plus/minus 3º in the elevation (vertical plane, respectively H-plane). The main beam typically points at boresight. When a radome is mounted onto the antenna assembly, the radome to antenna distance is typically of λ/2 (around 1.9 mm) within the band of operation (76-81 GHz) for automotive radar applications. λ=lambda herby represents the wavelength.

Adjacent to the at least one antenna aperture the front face of the antenna assembly further comprises scattering elements by which primary rays, impacting in the area of the scattering elements, are at least partially reflected by the scattering elements and thereby separated into first secondary rays and second secondary rays, such that the first secondary rays and the second secondary rays are different such that they cancel out each other at least partially by interference. Good results can be achieved when the scattering elements are with respect to the front face designed as protrusions and/or indentations or a combination thereof. Depending on the design, the depth of the at least one indentation may be linked to the specific phase distribution that is targeted to obtain a reflection that cancels out the rays reflected in an unwanted manner by interference. The phase change is typically induced by the reflection on the bottom surface of the at least one indentation. Good results can be achieved, when the bottom surface of the at least one indentation is an essentially planar surface which is arranged essentially parallel with respect to the front face of the antenna assembly. Preferably the scattering elements are having in the front face a layout (footprint) which is at least one element out of the group of the following elements or a combination thereof: rectangle, square, circle, ellipse, C-shaped, ring-shaped, S-shaped. The scattering elements can be designed with a single polarization (rectangular, elliptical, s-shaped, c-shaped) or with multiple polarizations (squared/circular/ring). The at least one indentation has a layout which is related to the working operating frequency and the polarization of the electromagnetic waves. The extension of the scattering elements in the direction perpendicular to polarization vector may correspond with around 0.72 (free space) for rectangular/elliptical and square/circular. The circumference of the ring shaped scattering elements may correspond with double the length. S-shaped and c-shaped scattering elements are used to reduce the dimension. The phase change typically results from the depth of the at least one indentation. A typical dimension for the depth of the at least one indentation is λ/2. A typical dimension for the layout of the aperture of the at least one indentation is λ/4 times 0.72. For automotive applications with a wavelength of 77 GHz this results in a depth of the at least one indentation which is around 1.4 mm and a layout of the aperture of the at least one indentation of 1 mm times 2.8 mm. In a preferred variation the scattering elements are having perpendicular to the front face a cross-section which is essentially rectangular and/or pyramidal and/or a combination thereof.

Good results can be achieved when the scattering elements have a T-shaped layout or a cross shaped layout. A T-shaped layout can be formed by a horizontal rectangle arranged adjacent to a vertical rectangle. Alternatively, a cross shaped layout which can be formed by a horizontal rectangle and a vertical rectangle, whereby the center point of the horizontal rectangle and the center point of the vertical rectangle coincide. Both the T-shaped and the cross shaped layouts allows to cancel both, horizontally and vertically polarized waves. When the scattering elements are designed as indentations which are flush mounted in the front face, the antenna assembly has a favorably thin overall thickness. An antenna device comprising an antenna assembly which comprises scattering elements in form of indentations further has the advantage that a radome can be flush mounted with the front face of the antenna assembly. The protrusions and/or indentations are configured to at least partially reflect the primary rays not impacting in the area of the antenna aperture. Said secondary rays are influenced by the protrusions and/or indentations in a way, that the reflected parts of the primary rays—first secondary rays and second secondary rays—are canceled out to a large extent by each other due to interference. In comparison to blind/dummy antennas, the scattering elements do not require additional waveguide routing. With an antenna assembly designed comprising a front and a back layer the protrusions or indentations are usually arranged at the front layer only. Therefore, the complexity and additional production effort can be reduced significantly. The scattering elements usually have a resonant character such that their dimension is strongly connected to the wavelength. The scattering elements are preferably configured to perturb the electromagnetic field distribution such that a peculiar current distribution is created at the front face of the antenna assembly. Preferably a phase delay is introduced such that the rays which are reflected in an unwanted manner are diminished or cancelled out due to interference with each other.

Good results can be achieved when the scattering elements are arranged at the front face of the antenna assembly in a periodical or quasi-periodical pattern of scattering elements. The scattering elements of the pattern of scattering elements are preferably arranged in rows and/or columns. The scattering elements can e.g., by arranged in at least two parallel rows. The at least two rows are typically laterally spaced apart with respect to each other. Preferably, the scattering elements of each row are equally spaced apart from each other. To achieve a reflection wherein the first secondary rays and the second secondary rays cancel each other out due to interference, the scattering elements of two adjacent rows are usually offset to each other in the direction of the rows. The scattering elements of two adjacent rows are preferably offset to each other in the direction of the rows with a spatial displacement of essentially λ/2 in direction of the rows or in a direction perpendicular to the direction of the rows such that a phase difference of 180° is achieved such that the reflected rays cancel out each other by interference. The scattering elements arranged at the front face adjacent to the at least one antenna aperture are preferably arranged essentially parallel with respect to the at least one antenna aperture such that horizontal plane rays can be cancelled. Alternatively, the at least one antenna aperture can be placed in the vertical plane of the antenna assembly such that rays in the vertical plane can be canceled. Depending on the percentage of the antenna's top surface coverage by scattering elements a reduction of the scattering coefficient of more than 65% can be achieved. Depending on the periodic spacing (p) of the scattering elements and the number of scattering elements at the front face of the antenna assembly, a phase between 0° and 180° is created instead of a uniform phase distribution without the scattering structure. The periodic spacing is defined as the lateral distance between two scattering elements of neighboring rows. In a preferred variation the scattering elements are arranged at the front face of the antenna assembly based on glide symmetry (glide reflection). The scattering elements are therefore preferably mirrored with respect to the at least one antenna aperture and shifted in a lateral direction with respect to the at least one antenna aperture. This particular periodicity supports the generation of the required 0° and 180° phase distribution. Ideally the number of scattering elements arranged adjacent to the at least one antenna aperture in the desired direction may be infinite. In theoretically feasible variations the number of scattering elements could be reduced down to 1. In a preferred variation the periodic spacing is a multiple of λ/2. A different approach to reduce the interference is to use scattering elements with a random depth such that a reflect array like structure is created which has a random phase distribution such that the interference waves are scattered in a diffused way. The scattering elements arranged at the front face can also differ in length. In a variation the scattering elements can each have essentially the same length, which is defined as the base length. In an alternative variation a number of the scattering elements has also the base length and the remaining scattering elements have double the length or a multiple of the base length. Good results can be achieved when the remaining scattering elements have double or four times the base length, but also odd multiple are possible. Preferably the scattering elements of the base length and double the base length are arranged in an alternating manner.

In a variation, the scattering elements are arranged in at least two parallel rows. The at least two rows are typically laterally spaced apart with respect to each other. Preferably, the scattering elements of each row are equally spaced apart from each other and the at least two rows are offset to each other in the direction of the rows with a spatial displacement of essentially λ in direction of the rows. A displacement of essentially λ allows that an additional scattering element can be arranged between two neighboring scattering elements, which additional scattering element can be arranged essentially perpendicular with respect to the scattering elements of the at least two rows. The perpendicular displacement with respect to the direction of the rows makes it possible to also cancel reflections from waves, which are vertically polarized. The scattering elements arranged in the direction of the rows are configured to cancel horizontally polarized waves and the scattering elements arranged rotated by 90° are configured to cancel vertically polarized waves.

Good results to reduce the ripples in the radiation pattern can be achieved, when the antenna assembly comprises at least one outer edge which is saw teeth-shaped. In a preferred variation the antenna assembly comprises at least two outer edges which are saw teeth-shaped and arranged opposite to each other with respect to the antenna assembly. The structure changes the direction of the surface currents on the edge of the antenna leading to destructive interference of backscattering of impinging fields. While minor amplitude and phase errors are introduced by edge effects due to the finite dimensions of the antenna's metallic top surface. By adding the saw tooth structure on the edge the negative influence of edge effects can be reduced. Among others it reduces the ripples in radiation pattern, normally appearing due to the knife edge refraction on the antenna edge. Thanks to this measure the standard deviation of the angular radiation pattern can be reduced which is crucial for optimal performance of the radar. The saw tooth can be realized either by changing the 3D shape of plastic or by selective metallization on the edges.

In a preferred variation the antenna device comprises a radome which at least partially covers the front face of the antenna assembly. In theory, the optimum would be a radome interaction with a radome made of materials similar to air or an extremely thin radome, which is only of limited use from a practical mechanical point of view. The known radomes are arranged with a distance of essentially λ/2 distance (≈2 mm for 77 GHz automotive radome) with respect to the antenna assembly. This distance is usually chosen to avoid strong interaction between the antenna assembly and the radome. With a radome according to the present disclosure the distance between the antenna assembly and the radome can be reduced to essentially zero. In a preferred variation the radome has a back face which is at least partially flush mounted to the front face of the antenna assembly. The scattering elements in form of indentations make it possible that the radome is flush mounted with the antenna assembly. Good results can be achieved when the radome is plate shaped and has an essentially uniform thickness. In a preferred variation the back face of the radome may have at least one recess configured to improve the radiation. Usually, a part of the energy radiated by the antenna assembly remains captured in the radome. The recess minimizes the thickness of the radome and therefore losses of radiation are minimized. In an alternative variation, the back face of the radome follows the contour of front face and the scattering elements. Therefore, the radome may have a pattern of protrusions which corresponds to the pattern of scattering elements arranged at the front face of the antenna assembly and therefore the depth of the scattering structure can be reduced. The protrusions preferably engage the indentations in a mounted state. In a variation the radome comprises in the area above the at least one antenna aperture a dome-shaped lens such that incoming primary rays are focused with respect to the antenna aperture.

Besides the scattering elements which are arranged adjacent to the at least one antenna aperture on the front face of the antenna assembly, the front face of the antenna assembly can further also at least be partially made of or comprise absorbing material. While the scattering elements are configured to at least partially reflect the primary rays impacting in the area of the scattering elements, and thereby separate them into first secondary rays and second secondary rays, the absorbing material is configured to at least partially absorb the primary rays impacting in the area of the absorbing material. The absorbing material can fully or partly cover the antenna assembly. Good results can be achieved when the absorbing material is arranged on or in the front face in form of a layer, thereby covering essentially the overall front face except for the area covered by the at least one antenna aperture and the area covered by the scattering elements.

The absorbing material can be assembled to the antenna assembly in form of a separate layer of absorbing material, which is joined with the front face of the antenna assembly. The layer of absorbing material can be joined mechanically by fastening means, e.g., by screwing or clamping. Alternatively, or in addition, the layer of absorbing material can be joined by welding, gluing, hot stamping, clipping, pressfit, soldering etc. The absorbing material is typically a resin or composite, e.g., a hybrid material with electromagnetic absorbing properties. The absorbing material can either be assembled by embedding it into the front face of the antenna assembly, preferably by injection molding it into a cavity of the base material or be arranged onto the front face.

An efficient manufacturing process can be achieved when the antenna assembly is made by multicomponent injection molding or in-mold-decoration. A multicomponent injection molding processes typically includes more than one plastic material, whereby at least one plastic material has electromagnetic (EM) absorbing properties. Alternatively, or in addition, the antenna assembly can be subjected to a complete or selective surface treatment process. Once the front and the back layer of the antenna assembly are fabricated, a layer of paint or coating can be at least partially applied to the front face of the antenna assembly. The paint or coating preferably also has electromagnetic (EM) absorbing properties. In a variation the plastic material of the antenna assembly can have electromagnetic (EM) absorbing properties. In an alternative variation, the front face of the antenna assembly can be completely metalized in a first step and the metallization is removed partially in a second step in areas where electromagnetic absorption is desired.

Alternatively, or in addition, the absorbing material can be arranged on the inner side of the radome, facing the antenna assembly in the mounted state. A separate layer of absorbing material can be connected to the radome using joining techniques, e.g., screwing, clamping, welding, gluing, hot stamping, clipping, press-fit, soldering etc. The absorbing material can be attached to or embedded in the radome. The absorber can also be assembled with a distance with respect to the radome. The antenna assemblies according to the present disclosure are usually part of an antenna device. In a preferred variation the antenna device comprises an electronic component, a printed circuit board (PCB) and at least one antenna assembly and a radome. Typically, the elements of the antenna device are enclosed in a case which is sealed by the radome for mechanical protection. Although a radome is usually necessary to protect the antenna assembly from environmental influences, the radome usually interacts with the radiation characteristics of the antenna assembly in an unwanted manner and negatively impacts the radiation pattern, gain and phase purity. In a variation of the antenna device, an electronic component is arranged on a printed circuit board. The signal coming from the electronic component (e.g., a radar chip mounted on a PCB board) is typically coupled into a waveguide feeding aperture and propagates towards at least one antenna aperture configured to emit an outgoing signal of rays through the air-filled hollow wave guide structure. The at least one antenna aperture configured to emit an outgoing signal of rays is foreseen to be reflected by an external object and return at least partially as primary rays. The at least one antenna aperture configured to emit an outgoing signal of rays is preferably arranged at the front face of the antenna assembly. The at least one hollow wave guide structure is arranged within the bottom antenna layer or arranged partially within both layers and interconnects the at least one feeding aperture and antenna aperture configured to emit an outgoing signal of rays. Alternatively, or in addition the wave guide structure can also be designed as ridge wave guide, gap wave guide, or ridge gap wave guide. The antenna assembly can also comprise a number of antenna apertures and antenna aperture configured to emit an outgoing signal of rays arranged at the front face of the antenna assembly, wherein the antenna aperture configured to emit an outgoing signal of rays may serve as transmitter (TX) and the at least one antenna aperture serves as receiver (RX). Each antenna aperture consists of at least one radiating element which can be a horn and/or a slot shaped element. The at least one antenna aperture can be designed as a single radiating element and/or an array of radiating elements. The walls of the hollow wave guide structure, the at least one antenna aperture, the waveguide channel, the waveguide splitter, and the waveguide array can be metallic or metallized. All variations of the of the antenna assembly are preferably designed such that they are suitable for molding manufacturing techniques. The antenna assembly is preferably made by either metallized plastic injection molding or die casting. Therefore, the corners of the antenna assembly are typically rounded such that all vertical edges have radii and that all the scattering elements have drafted walls. The scattering elements are preferably designed such that the manufacturability for molding techniques is improved. This results in optimal surface finishing and mechanical stability/robustness of the layers of the antenna assembly. In addition to that, the drafts of the vertical walls are also selected to optimize thickness and quality of the metallization layer if plastic injection molding is selected for the antenna top layer and/or antenna bottom layer. Due to the particular metallization techniques preferably selected for this concept (e.g., PVD, sputtering, spraying), vertical walls would not allow to have the enough thickness and quality of the metallic layer to guarantee satisfactory RF performance at MMW. In this regard, the use of drafted wall allows to have a wider projected surface improving the metallization process.

Antenna devices for automotive radar applications, typically comprise a chip (MMIC), wherein the radar is realized on the chip. Electronic systems/components are usually arranged on a PCB. All of these electronic systems/components emit electromagnetic signals which often contribute to an overall noise level within the antenna device. The single channels of the radar chip emit interference signals at the radar's frequency of operation, which may cause unwanted cross-talk in the other radar channels and/or radar chip if multiple radar chips are used. The continuous search of increased overall sensor performances calls for a mitigation of this interference. The increased noise and the interference reduce the radar sensor performances while the noise level is increased. As a result, the sensor can get desensitized which decreases the accuracy respectively even the probability of detection. In case of printed circuit board antennas, the possibilities to mitigate this problem are limited. Antenna devices with waveguide antenna assemblies show multiple advantages in comparison to printed circuit board antenna assemblies. The antenna assembly can comprise at least one metalized cavity. The metalized cavity is preferably arranged at a back face of the antenna assembly. In case of a plastic waveguide antenna assembly which comprises at least two layers, the metalized cavity is preferably arranged at the back part of the antenna assembly. The at least one chip can be arranged at least partially within a metalized cavity such that the influence from surrounding electronic components and/or other chips is reduced. In an inventive concept, good results can be achieved, when the at least one cavity comprises at least one layer and/or coating of an electromagnetic absorbing material. In known antenna assemblies the at least one layer and/or coating of electromagnetic absorbing material is padded and/or glued to the at least one cavity. This, however, increases the overall cost of the antenna device. Good results can be achieved, when the absorbing material configured to absorb electromagnetic noise and/or unwanted radio frequencies, is already arranged at the antenna assembly by injection molding. Preferably the antenna assembly is injection molded such that at least one layer of absorbing material is injected into the cavity before the base material of the antenna assembly is injected in a second step. Good results can be achieved when the absorbing material is interconnected to the antenna assembly by injection molding. In a preferred variation the antenna assembly is made as a metallized plastic antenna of two or more components, wherein the plastic antenna or at least one of the layers of the plastic antenna includes at least partially absorbing material configured to reduce the interference. The absorbing material is preferably arranged at the antenna assembly in the area and/or above the chip. The part of the antenna assembly which comprises absorbing (lossy material) can either be left uncoated or coated with very thin metallic layer. Thus, the unwanted electromagnetic radiation from the chip and/or electronic components, causing electromagnetic compatibility problems, can be reduced due to absorption in such material. Therefore, the performance of the radar sensor can be sustained and there are no additional expenses on absorber padding. In a variation the antenna assembly can be made of absorbing material only. In this variation the antenna is additionally partially metalized. Preferably the antenna assembly is on the back side at least partially covered by an absorbing material. The same aspect can be used to mitigate the problem of bumper interaction as discussed above. If one of the materials used for injection molding has radio frequency absorbing properties, and this material is used to constitute the front face of the antenna assembly between the apertures, the energy of the secondary rays reflected from the front face of the antenna assembly can be highly reduced. The part of the antenna assembly comprising lossy material can either be left uncoated or coated with a very thin metallic layer to enable required function. Therefore, the applicant reserves the right to focus a divisional patent application on the additional inventive concept mentioned above.

It is to be understood that both the foregoing general description and the following detailed description present embodiments, and are intended to provide an overview or framework for understanding the nature and character of the disclosure. The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF SEVERAL VIEWS OF THE DRAWINGS

The herein described disclosure will be more fully understood from the detailed description given herein below and the accompanying drawings which should not be considered limiting to the disclosure described in the appended claims. The drawings are showing:

FIG. 1 shows a perspective view of a first embodiment of the antenna assembly;

FIG. 2 shows a comparison of the radiation pattern without bumper and with bumper in an elevation cut (left) and an azimuth cut (right);

FIG. 3 shows a second embodiment of the antenna assembly comprising two outer edges which are saw teeth-shaped;

FIG. 4 shows a comparison of the radiation pattern without saw tooth edge (blue) and with saw tooth edge (orange);

FIG. 5 shows schematically the separation of primary rays into first and second secondary rays;

FIG. 6 shows schematically a first and a second embodiment of the scattering elements;

FIG. 7a shows one suitable layout for the scattering elements;

FIG. 7b shows one suitable layout for the scattering elements;

FIG. 7c shows one suitable layout for the scattering elements;

FIG. 7d shows one suitable layout for the scattering elements;

FIG. 7e shows one suitable layout for the scattering elements;

FIG. 7f shows one suitable layout for the scattering elements;

FIG. 7g shows one suitable layout for the scattering elements;

FIG. 7h shows one suitable layout for the scattering elements;

FIG. 7i shows one suitable layout for the scattering elements;

FIG. 8 shows schematically a first arrangement of scattering elements;

FIG. 9 shows schematically a second arrangement of scattering elements;

FIG. 10 shows schematically an embodiment of scattering elements with a T-shaped layout;

FIG. 11 shows schematically an embodiment of scattering elements with a cross shaped layout;

FIG. 12 shows a first embodiment of the radome in a perspective view wherein the radome is folded away from the antenna assembly by 90°;

FIG. 13 shows the first embodiment according to FIG. 8 in a cross-sectional view;

FIG. 14 shows a second embodiment of the radome in a perspective view wherein the radome is folded away from the antenna assembly by 90°;

FIG. 15 shows the second embodiment according to FIG. 10 in a cross-sectional view;

FIG. 16 shows a third embodiment of the radome in a perspective view wherein the radome is folded away from the antenna assembly by 90°;

FIG. 17 shows the third embodiment according to FIG. 12 in a cross-sectional view;

FIG. 18 shows a fourth embodiment of the radome in a perspective view;

FIG. 19 shows the fourth embodiment according to FIG. 14 in a cross-sectional view;

FIG. 20 shows a first embodiment of the antenna device in a perspective view from above with a cut-out;

FIG. 21 shows the embodiment of the antenna device according to FIG. 16 in an exploded view;

FIG. 22 shows a second embodiment of the antenna device in a perspective view from above with a cut-out;

FIG. 23 shows the embodiment of the antenna device according to FIG. 18 in an exploded view from the rear;

FIG. 24 shows a perspective view of a third embodiment of the antenna assembly;

FIG. 25 shows an exploded perspective view of the third embodiment of the antenna assembly according to FIG. 24;

FIG. 26 shows a perspective view of a fourth embodiment of the antenna assembly;

FIG. 27 shows an exploded perspective view of the fourth embodiment of the antenna assembly according to FIG. 26;

FIG. 28 shows a fifth embodiment of the radome in a perspective view; and

FIG. 29 shows a fifth embodiment of the radome in a perspective exploded view.

### DETAILED DESCRIPTION OF THE INVENTION

Reference will now be made in detail to certain embodiments, examples of which are illustrated in the accompanying drawings, in which some, but not all features are shown. Indeed, embodiments disclosed herein may be embodied in many different forms and should not be construed as limited to the embodiments set forth herein; rather, these embodiments are provided so that this disclosure will satisfy applicable legal requirements. Whenever possible, like reference numbers will be used to refer to like components or parts.

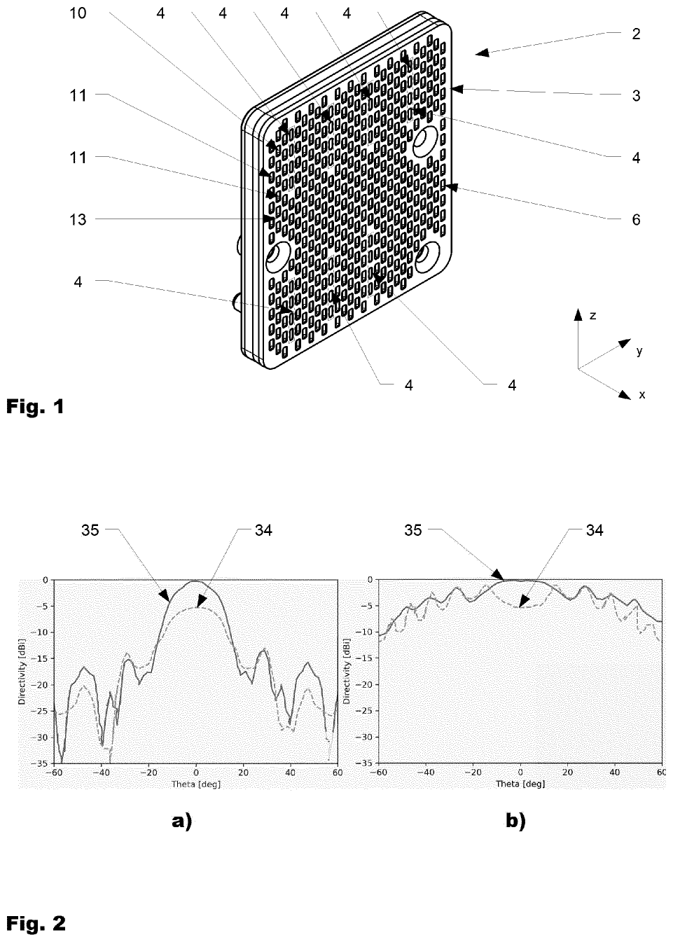

FIG. 1 shows a perspective view of a first embodiment of the antenna assembly 2. As best visible in FIG. 1, the antenna assembly 2 for an antenna device 1 for automotive radar applications comprises a front face 3 in which at least one antenna aperture 4 is arranged configured to receive an incoming signal in form of primary rays 5 impacting in the antenna aperture 4. In the shown variation several antenna apertures 4 are present which are arranged in groups (schematically indicated by dotted lines). The front face 3 of the antenna assembly 2 comprises adjacent to the at least one antenna aperture 4 scattering elements 6 by which primary rays 5, as schematically indicated in FIG. 5, impacting in the area of the pattern of scattering elements 6, are at least partially reflected by the scattering elements 6 and thereby separated into first secondary rays 7 and second secondary rays 8, such that the first secondary rays 7 and the second secondary rays 8 cancel out each other at least partially by interference. The shown scattering elements 6 are with respect to the front face 3 designed as indentations 10. Alternatively, the scattering elements can also be designed as protrusions 9 and/or a combination of protrusions and indentations 10. The shown scattering elements 6 are arranged in parallel rows 11, wherein the scattering elements of each row are equally spaced apart from each other. In the shown embodiment the scattering elements 6 of two adjacent rows are arranged with respect to each other in a periodic spacing 13 such that the phase shift of the reflected first and second secondary rays is 180°. In a preferred variation, the periodic spacing 13 is a multiple of λ/2. As can be seen in FIG. 2, which shows a comparison of the radiation pattern without bumper and with bumper in an elevation cut (left) In FIG. 2a and an azimuth cut (right) in FIG. 2b. From FIGS. 2a and 2b it can be seen that the scattering elements cause a suppression of ripples in the radiation pattern. The graphs in FIGS. 2a and 2b show the directivity of the antenna assembly over the angle. As can be seen the dotted lines, showing the performance of the antenna assembly without scattering elements 34 and the continuous line showing the performance 35 with scattering elements 6.

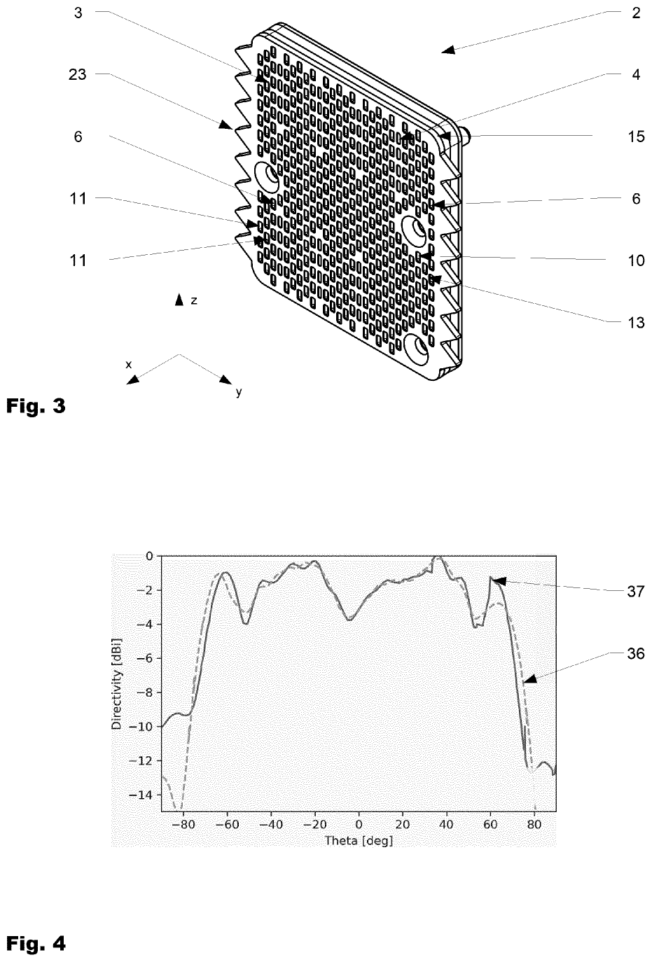

FIGS. 3 and 4 show an embodiment of a metallized antenna assembly 2, wherein the antenna assembly 2 comprises two outer edges 15 which are in the shown embodiment saw teeth-shaped 23 and arranged opposite to each other with respect to the antenna assembly 2. The saw teeth-shaped 23 outer edges 15 change the direction of the currents at the front face 3 such that the outer edges 15 of the antenna assembly 2 cause destructive interferences of backscattering of impinging fields. While minor amplitude and phase errors are introduced by the outer edge 15 of the antenna assembly 2, effects due to the finite dimensions of the antenna's metallic top surface. The saw-teeth shaped 23 outer edges 15 are configured to reduce the negative influence of the edge effects. The saw-teeth shape 23 can be realized either by changing the 3D shape of plastic or by selective metallization on the outer edges 15. As can be seen in FIG. 4, the saw teeth-shaped 23 outer edges 15 reduce the ripples in the radiation pattern which normally appear due to the knife edge refraction on the outer edge 15 of the antenna assembly 2. The saw-teeth shaped 15 outer edges 23 are configured to reduce the standard deviation of the angular radiation pattern which is crucial for optimal performance of the antenna device 1. The graph in FIG. 4 shows the directivity of the antenna assembly over the angle. As can be seen the dotted line shows the performance of the antenna assembly without saw-teeth shaped outer edges 36 and the continuous line showing the performance 37 with saw-teeth shaped outer edges 15.

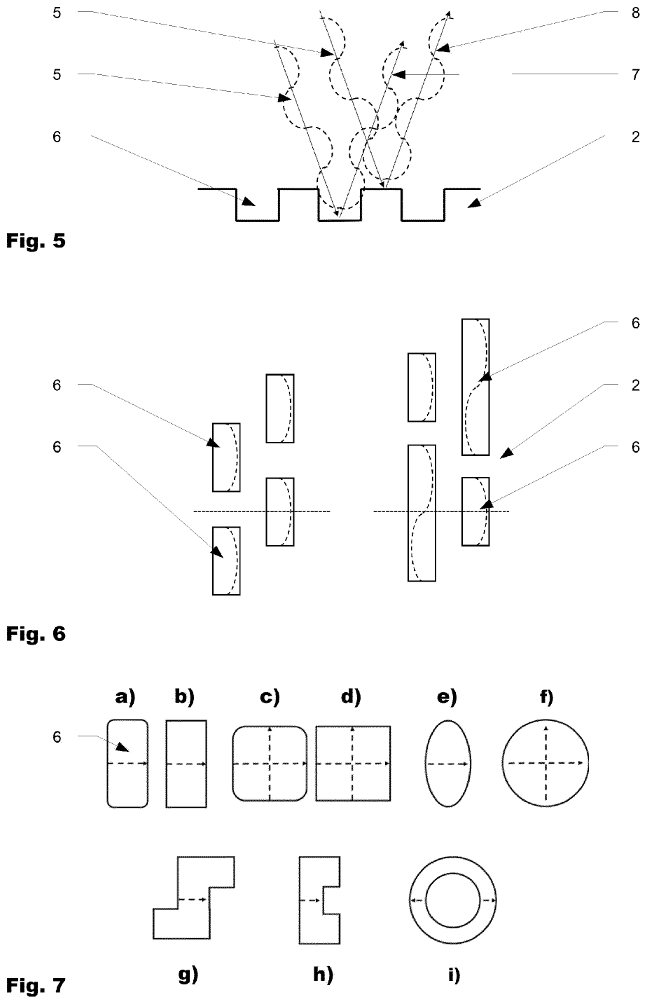

FIG. 5 shows schematically the separation of primary rays 5 into first 7 and second 8 secondary rays. The incoming primary rays 5 are reflected by the antenna assembly 2. The first incoming primary ray 5 is reflected by the front face 3 of the antenna assembly 2. The second incoming primary ray 5 is reflected by the scattering element 6. Due to the geometry of the scattering element 6 the resulting first 7 and second 8 secondary rays do have a phase difference of λ/2. As indicated by the dotted lines, the first 7 and the second 8 secondary rays are in opposite phase and therefore cancel each other due to destructive interference. FIG. 6 schematically shows two variations of scattering elements 6. The shown embodiments differ in that the scattering elements 6 differ in length. The scattering elements 6 of the first embodiment (left side in picture) each have essentially the same length, which is defined as the base length. The scattering elements 6 of the second embodiment (right side in picture) have either also the base length or double the length. Preferably the scattering elements 6 of the base length and double the base length are arranged in an alternating manner. The scattering elements 6 of two adjacent rows 12 are offset to each other in the direction of the rows with a spatial displacement of around λ/2 such that in the direction of the rows or in a direction perpendicular to the rows a phase difference of 180° is achieved such that the reflected rays cancel out each other by interference. FIGS. 7a to i show a number of suitable layout 14 geometries (footprint) for the scattering elements 6. In a preferred variation, the layout 14 corresponds to at least one element out of the group of the following elements or a combination thereof: rectangle (FIG. 7a, b), square (FIG. 7c, d), ellipse (FIG. 7e), circle (FIG. 7f), S-shaped (FIG. 7g), C-shaped (FIG. 7h), ring-shaped (FIG. 7i).

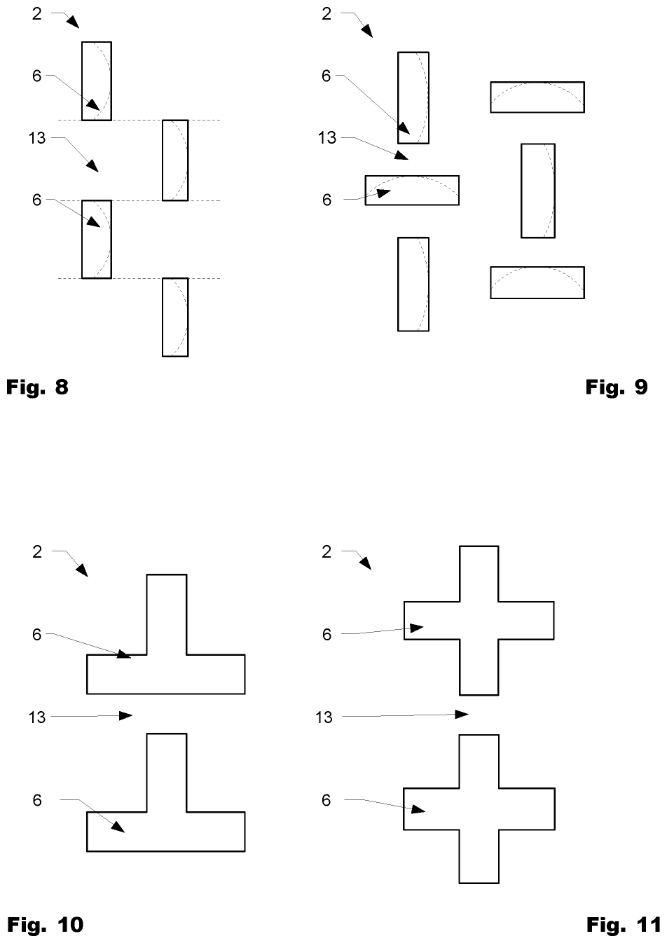

FIGS. 8 and 9 show schematically a first (FIG. 8) and a second (FIG. 9) arrangement of scattering elements 6. The shown scattering elements 6 are arranged in at least two parallel rows. The at least two rows are typically laterally spaced apart with respect to each other. The shown scattering elements 6 of each row are equally spaced apart from each other. In the shown variation, the scattering elements 6 of the shown two adjacent rows are offset to each other in the direction of the rows with a spatial displacement of at least λ/2. Good results can be achieved when the spatial displacement corresponds to λ in direction of the rows. This design has the advantage that additional scattering elements 6 can be arranged which are arranged essentially perpendicular with respect to the two rows, as can be obtained best from FIG. 9. The perpendicular displacement with respect to the direction of the rows makes it possible to also cancel reflections from waves which are vertically polarized. The scattering elements 6 arranged in the direction of the rows are configured to cancel horizontally polarized waves and the scattering elements 6 arranged rotated by 90° are configured to cancel vertically polarized waves.

FIGS. 10 and 11 show an embodiment of scattering elements 6 with a T-shaped layout (FIG. 10) and an embodiment of scattering elements 6 with a cross shaped layout (FIG. 11). The scattering elements shown in FIG. 10 have a T-shaped layout which is formed by a horizontal rectangle arranged adjacent to a vertical rectangle. This layout allows to cancel both, horizontally and vertically polarized waves. The same applies to the cross shaped layout shown by FIG. 11, which is achieved by a horizontal rectangle and a vertical rectangle, whereby the center point of the horizontal rectangle and the center point of the vertical rectangle coincide. This layout allows to cancel both, horizontally and vertically polarized waves.

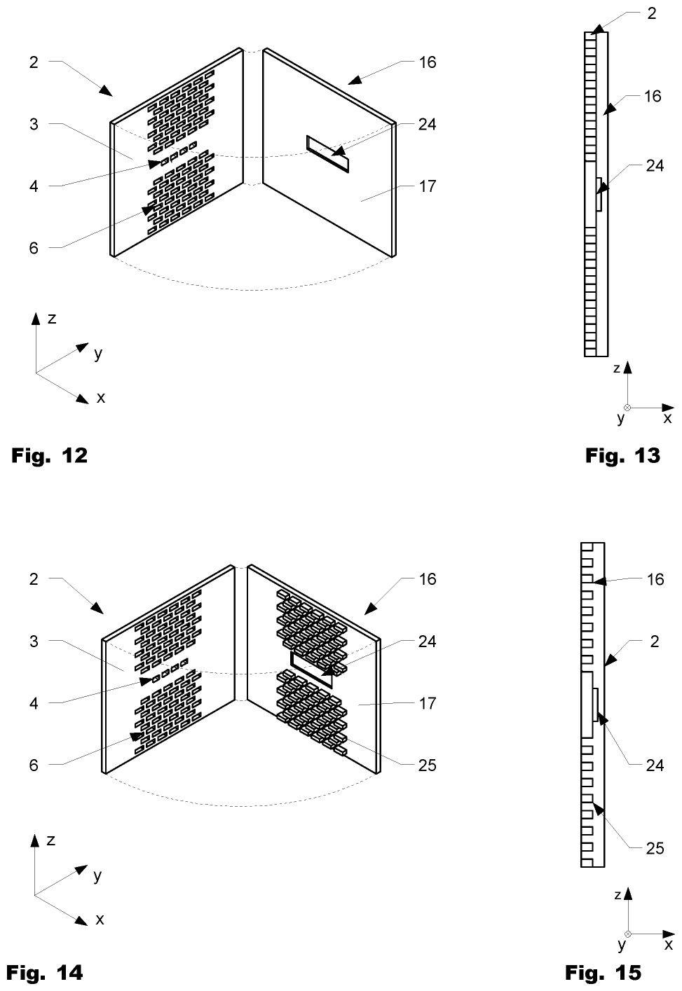

FIGS. 12 and 13 show a first embodiment of a radome 16 in a perspective view wherein the radome 16 is folded away from the antenna assembly by 90°. FIG. 13 shows the first embodiment according to FIG. 12 in a cross-sectional view. The shown radome 16 is essentially flush mounted with the front face 3 of the antenna assembly 2, wherein the back face 17 of the radome 16 is essentially flush mounted to the front face 3 of the antenna assembly 2. This has the advantage that reflections of primary rays 5 by the radome 16 can be prevented and electromagnetic rays are not radiated into the air and bounce back on the radome 16 as they are directly radiated out of the radome 16. Furthermore, the flush mounted radome 16 reduces the overall thickness of the antenna device 1. The radome 16 of the first embodiment comprises a recess 24 which is arranged at the back face 17 of the radome 16, essentially congruent with respect to the at least one antenna aperture 4 arranged at the front face 3 of the antenna assembly 2. The recess 24 can be essentially rectangular. By a radome 16 with an overall thickness of 2 mm (λ/2 free space) a big part of the energy radiated by the antenna assembly 2 will remain captured in the radome 16 in form of surface wave. The recess 24 overcomes this problem by making the radome 16 thinner, at least in the area congruent to the antenna aperture 4.

FIGS. 14 and 15 show a second embodiment of the radome 16 in a perspective view wherein the radome 16 is folded away from the antenna assembly by 90°. FIG. 15 shows the second embodiment according to FIG. 14 in a cross-sectional view. The shown radome 16 is essentially flush mounted with the front face 3 of the antenna assembly 2, wherein the back face 17 of the radome 16 is essentially flush mounted to the front face 3 of the antenna assembly 2. In addition, the radome 16 of the shown embodiment comprises at least one protrusion 25 that is arranged at the back face 17 of the radome 16 and protrudes towards the front face 4 of the antenna assembly. The at least one protrusion 25 arranged at the back face 17 of the radome 16 is configured to at least partially engage with and partially fill in at least one of the scattering elements 6. This has the positive effect that the depth (d) of the scattering elements 6 can be reduced, due to the dielectric loading of the protrusion 25. This also enables a further overall reduction of the thickness of the antenna assembly 2 and therefore the thickness of the antenna device 1 as such can also be reduced.

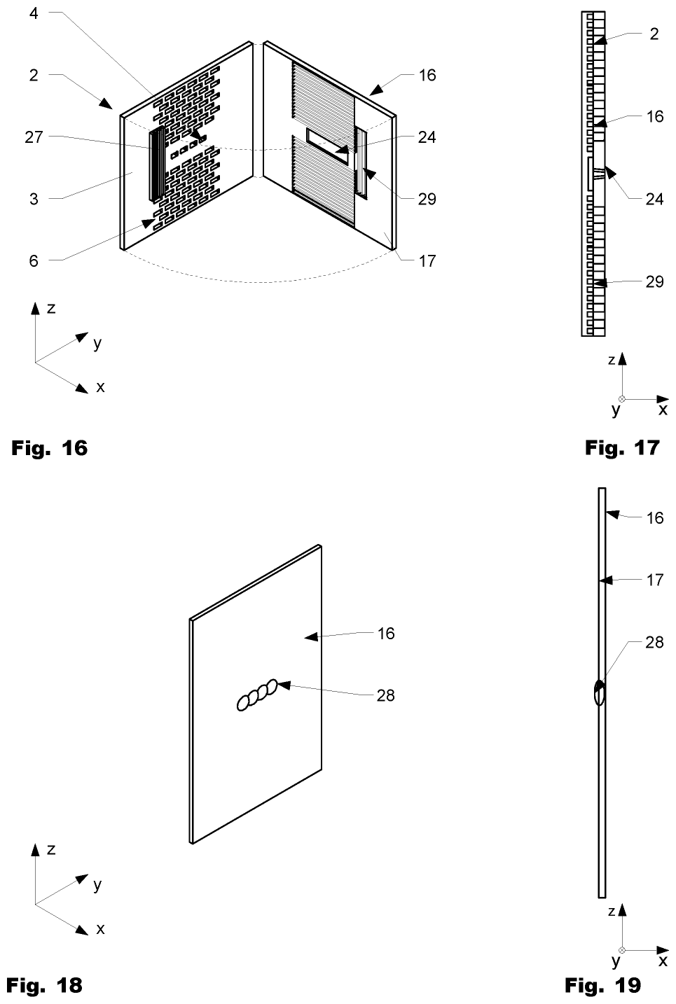

FIG. 16 and FIG. 17 a third embodiment of the radome in a perspective view wherein the radome is folded away from the antenna assembly by 90°. FIG. 13 shows the third embodiment according to FIG. 12 in a cross-sectional view. The shown radome 16 is essentially flush mounted with the front face 3 of the antenna assembly 2, wherein the back face 17 of the radome 16 is essentially flush mounted to the front face 17 of the antenna assembly 2. In addition, the shown radome 16 comprises a number of grooves 26. The grooves 26 are arranged at the back face 17 of the radome 16 and preferably arranged spaced apart from each other and in parallel to the at least one antenna aperture 4. The front face 3 of the antenna assembly 2 further comprises a number of bars 27 which are arranged parallel to each other and essentially perpendicular to the at least one antenna aperture 3. The number of bars 27 is designed to engage with a corresponding number of recesses 28 arranged at the back face 17 of the radome 16. The number of grooves 26 is configured to reduce the surface waves. The number of bars 27 is configured to improve the radiation pattern of the antenna assembly 2 and to stop the propagation of surface waves in the vertical direction. The dimension of the grooves 26 arranged at the back face 17 of the radome 16 as well as the number of bars 27 depends on the radome 16 thickness end the dielectric constant of the radome 16 material. For a 1.4 mm thick radome with dielectric constant of 3.46 the grooves' 26 height (h) is 1 mm and width (w) is 0.7 mm. The wall thickness ws is 0.4 mm and hs is 0.4 mm.

FIG. 18 and FIG. 19 show an embodiment of the radome 16 which comprises at least one lens 28, wherein the lens 28 is designed such that most of the power can be radiated in boresight direction at the front face 3 of the antenna assembly 2 avoiding excitation of surface waves, since the lens 28 help to collimate the power in boresight direction. These, techniques take advantage of 3D structure of the antenna assembly 2 and the radome 16. Furthermore, the lens 28 help to reduce the size of the antenna aperture 4 which can in terms relax the conflict between antenna placement for proper function of beam former and requirements on beam width and directivity of antenna. The radii of the lens 28 depend strongly on the radome 16 material and type of antenna aperture 4.

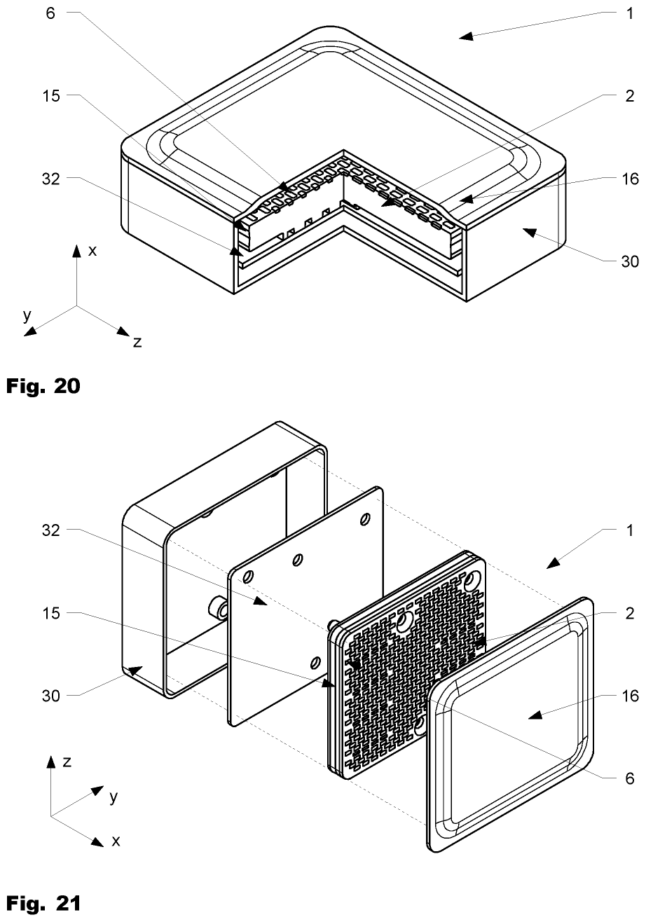

FIGS. 20 and 21 show a first embodiment of the antenna device 1, wherein the antenna assembly is arranged within a case 30. In the shown embodiment the antenna assembly 2 is essentially fully enclosed by the case 30. The shown antenna assembly 2 is designed as a waveguide antenna. The at least one antenna aperture 4 connects to a hollow wave guide structure 31 arranged inside the antenna assembly 2. The hollow waveguide structure 31 is interconnected to an electronic component 32. In the shown embodiment the electronic component 32 is arranged at the back side of the antenna assembly 2 with respect to the front face 3 of the antenna assembly 2. The antenna device 1 also comprises a printed circuit board 33 and a thereon arranged electronic component 32. Besides the at least one antenna aperture 4 arranged at the front face 3 the shown antenna assembly 2 further comprises at least one antenna aperture 4 configured to emit an outgoing signal of rays which is foreseen to be reflected by an external object and return at least partially as primary rays 5. Alternatively, the at least one antenna aperture 4 can also be designed as horn antenna. The scattering elements 6 of the shown embodiment are having perpendicular to the front face a cross-section which is essentially rectangular and/or pyramidal and/or a combination thereof. The scattering elements 6 are having in the front face a layout 14 which is at in the shown variation rectangular. As best visible in FIG. 16, the shown radome 16 is arranged spaced apart from the front face 3 of the antenna assembly 2. Alternatively, the radome 16 can also be flush mounted with the front face 3 of the antenna assembly 2. In a variation the antenna assembly 2 can be at least in the area of the scattering elements 6 partially be covered or consist of a material absorbing the primary rays 5 at least partially.

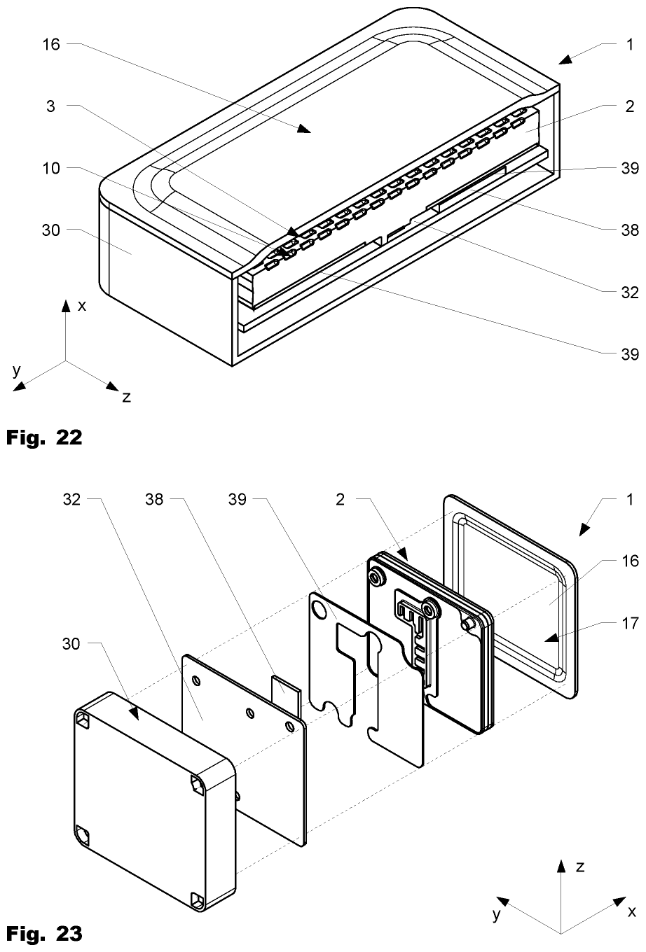

FIGS. 22 and 23 show a second embodiment of the antenna device 1, wherein the antenna assembly 2 is arranged within a case 30. In the shown embodiment the antenna assembly 2 is essentially fully enclosed by the case 30. The shown antenna assembly 2 is designed as a waveguide antenna. The at least one antenna aperture 4 connects to a hollow wave guide structure 31 arranged inside the antenna assembly 2. The hollow waveguide structure 31 is interconnected to an electronic component 32. In the shown embodiment the electronic component 32 is arranged at the back side of the antenna assembly 2 with respect to the front face 3 of the antenna assembly 2. The antenna device 1 also comprises a printed circuit board 33 and a thereon arranged electronic component 32. Besides the at least one antenna aperture 4 arranged at the front face 3 the shown antenna assembly 2 further comprises at least one antenna aperture 4 configured to emit an outgoing signal of rays which is foreseen to be reflected by an external object and return at least partially as primary rays 5. As best visible in FIG. 16, the shown embodiment comprises a layer of absorbing material 39. The shown embodiment comprises a chip (MMIC) 38. The shown antenna assembly is made by injection molding. The shown embodiment of the antenna assembly 2 comprises two injection molding materials, wherein one of them has electromagnetic absorbing properties. The layer of absorbing material 39 is arranged at the back face of the antenna assembly 2. In a preferred variation the layer of absorbing material 39 and the base material are made in one production step within one cavity. Preferably by two component injection molding.

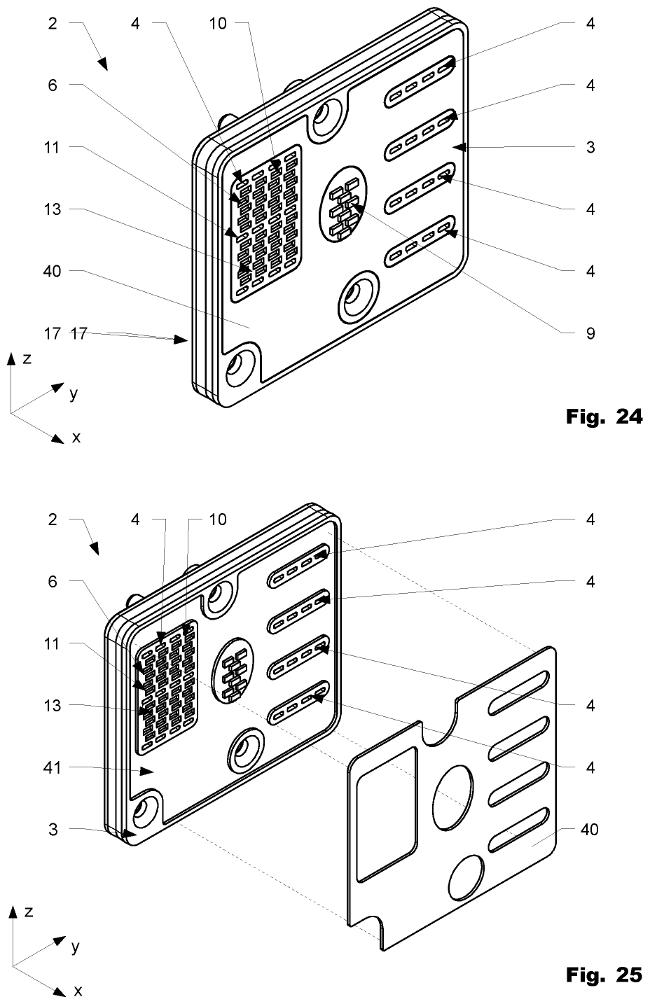

FIGS. 24 and 25 show a perspective view of a third embodiment of the antenna assembly 2. In the front face 3 of the shown embodiment antenna apertures 4 are arranged configured to receive an incoming signal in form of primary rays 5 impacting in the antenna aperture 4. The shown antenna apertures 4 are arranged in groups. The shown scattering elements 6 are with respect to the front face 3 designed as indentations 10. In addition, some of the shown scattering elements 6 are arranged in parallel rows 11, wherein the scattering elements 6 of each row are equally spaced apart from each other. Besides the scattering elements 6 which are arranged adjacent to the at least one antenna aperture 4 on the front face 3 of the antenna assembly 2, the shown antenna assembly 2 further comprises a layer of absorbing material 40. While the scattering elements 6 are configured to at least partially reflect the primary rays 5 impacting in the area of the scattering elements 6, and thereby separate them into first secondary rays 7 and second secondary rays 8, the shown layer of absorbing material 40 at least partially absorbs the primary rays 5 impacting at the absorbing material. As can be seen in the figures, the layer of absorbing material 40 can fully or partially cover the antenna assembly 2. In the shown variation the layer of absorbing material 40 is arranged on or in the front face 3 and covers essentially the overall front face 3 except for the area covered by the antenna apertures 4 and the area covered by the scattering elements 6.

As can be obtained best from FIG. 25, the shown layer of absorbing material 40 is assembled to the antenna assembly 2 in form of a separate layer of absorbing material 40, which is joined with the front face 3 of the antenna assembly 2. The shown absorbing material 40 can be joined mechanically by fastening means, e.g., by screwing or clamping. The shown layer of absorbing material 40 can be joined by welding, gluing, hot stamping, clipping, pressfit, soldering etc. The shown absorbing material 40 is made out of a resin or composite, e.g., a hybrid material with electromagnetic absorbing properties. The shown absorbing material 40 is embedding it into the front face 3 of the antenna assembly 2, into a cavity 41 arranged in the front face 3.

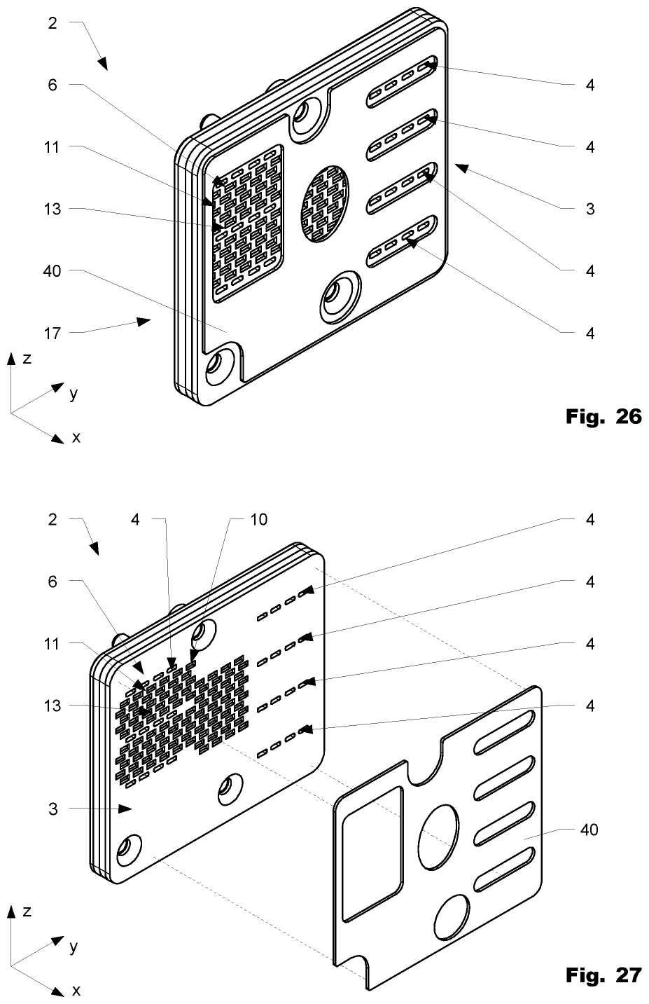

FIGS. 26 and 27 show a perspective view of a fourth embodiment of the antenna assembly 2. The shown embodiment is similar to the third embodiment shown in FIGS. 24 and 25. Besides the scattering elements 6 arranged adjacent to the at least one antenna aperture 4 on the front face 3 of the antenna assembly 2, the shown antenna assembly 2 further also comprises a layer of absorbing material 40. As can be seen in the figures, the absorbing material 40 can fully or partly cover the antenna assembly 2. In the shown variation the absorbing material 40 is arranged on or in the front face 3 and covers essentially the overall front face 3 except for the area covered by the antenna apertures 4 and the area covered by the scattering elements 6.

As can be obtained best from FIG. 27, the shown embodiment differs from the embodiment shown by FIGS. 24 and 25 in that the layer of absorbing material 40 is assembled to the antenna assembly 2 in form of a separate absorbing material 40, which arranged onto the front face 3 of the antenna assembly 2. The shown absorbing material 40 can be joined mechanically by fastening means, e.g., by screwing or clamping. The shown layer of absorbing material 40 can be joined by welding, gluing, hot stamping, clipping, pressfit, soldering etc. The shown absorbing material 40 is made out of a resin or composite, e.g., a hybrid material with electromagnetic absorbing properties. An efficient manufacturing process for the shown embodiment can be achieved when the antenna assembly 2 is made by multicomponent injection molding or in-mold-decoration. A multicomponent injection molding processes typically includes more than one plastic material, whereby at least one plastic material has electromagnetic (EM) absorbing properties. Alternatively, or in addition, the antenna assembly 2 can be subjected to a complete or selective surface treatment process. Once the front and a back layer of the antenna assembly are fabricated, a layer of paint or coating can be at least partially applied to the front face 3 of the antenna assembly 2.

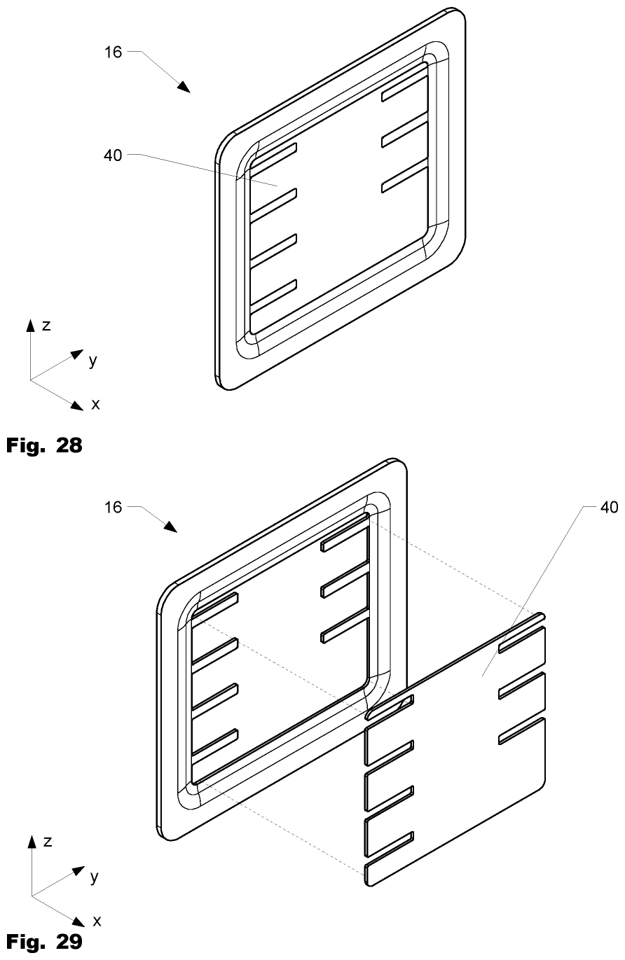

FIGS. 28 and 29 show a fifth embodiment of the radome 16 in a perspective view. In the shown embodiment, the absorbing material 40 is arranged on the inner side of the radome 16, facing the antenna assembly 2 in the mounted state. The separate absorbing material 40 is connected to the radome 16 using joining techniques, e.g., screwing, clamping, welding, gluing, hot stamping, clipping, press-fit, soldering etc. The absorbing material 40 can attached to or be embedded in the radome 16. The shown absorbing material 40 can also be assembled with a distance with respect to the radome 16.

Rather, the words used in the specification are words of description rather than limitation, and it is understood that various changes may be made without departing from the Spirit and scope of the disclosure.

1-24. (canceled)

25. An antenna device for automotive radar applications comprising:
a. an antenna assembly comprising a front face in which at least one antenna aperture is configured to receive an incoming signal in a form of primary rays impacting the at least one antenna aperture, and
b. the front face comprising, adjacent to the at least one antenna aperture, scattering elements by which primary rays, impacting in an area of the scattering elements, are at least partially reflected by the scattering elements and thereby separated into first secondary rays and second secondary rays, such that the first secondary rays and the second secondary rays cancel out each other at least partially by interference.

26. The antenna device according to claim 25, wherein the scattering elements are with respect to the front face selected from the group of: indentations, protrusions or a combination thereof.

27. The antenna device according to claim 25, wherein the scattering elements are arranged in at least two parallel rows.

28. The antenna device according to claim 25, wherein the scattering elements of each row are periodically or quasi-periodically spaced apart from each other.

29. The antenna device according to claim 28, wherein the scattering elements of each row are periodically or quasi-periodically spaced apart from each other between each other and between the rows.

30. The antenna device according to claim 25, wherein the scattering elements of two adjacent rows are offset to each other in a direction of the rows with a spatial displacement of essentially λ/2 in the direction of the rows such that a phase difference of 180° is achieved such that the reflected rays cancel out each other by interference.

31. The antenna device according to claim 25, wherein the scattering elements of two adjacent rows are offset to each other in a direction of the rows with a spatial displacement of essentially λ/2 in a direction perpendicular to the direction of the rows such that a phase difference of 180° is achieved such that the reflected rays cancel out each other by interference.

32. The antenna device according to claim 25, wherein the scattering elements of two adjacent rows are offset to each other in a direction of the rows with a spatial displacement of essentially λ and a displaced scattering element is arranged between two neighboring scattering elements of the respective rows.

33. The antenna device according to claim 32, wherein the displaced scattering element is arranged essentially perpendicular with respect to the direction of the rows.

34. The antenna device according to claim 25, wherein the scattering elements are arranged in a periodical or quasi-periodical pattern of scattering elements.

35. The antenna device according to claim 25, wherein the scattering elements are having in the front face a layout which is at least one element out of the group of the following elements or a combination thereof: rectangle, square, circle, ellipse, C-shaped, ring-shaped, S-shaped, cross-shaped, T-shaped.

36. The antenna device according to claim 25, wherein the antenna assembly comprises at least two outer edges which are saw teeth-shaped and arranged opposite to each other with respect to the antenna assembly.

37. An antenna device for automotive radar applications comprising:
a. an antenna assembly comprising a front face in which at least one antenna aperture is configured to receive an incoming signal in form of primary rays impacting the at least one antenna aperture, and
b. the front face comprising, adjacent to the at least one antenna aperture, scattering elements by which primary rays, impacting in an area of the scattering elements, are at least partially reflected by the scattering elements and thereby separated into first secondary rays and second secondary rays, such that the first secondary rays and the second secondary rays cancel out each other at least partially by interference, and
c. the antenna assembly in the area of the scattering elements is at least partially covered or consists of a material absorbing the primary rays at least partially.

38. The antenna device according to claim 37, wherein the absorbing material is arranged at the antenna assembly which at least partially covers the front face configured to absorb impacting primary rays.

39. An antenna device for automotive radar applications comprising
a. an antenna assembly comprising a front face in which at least one antenna aperture is configured to receive an incoming signal in form of primary rays impacting in the at least one antenna aperture, and
b. the front face comprising, adjacent to the at least one antenna aperture, scattering elements by which primary rays, impacting in an area of the scattering elements, are at least partially reflected by the scattering elements and thereby separated into first secondary rays and second secondary rays, such that the first secondary rays and the second secondary rays cancel out each other at least partially by interference. and
c. the antenna device comprises a radome which is at least partially covering the front face of the antenna assembly.

40. The antenna device according to claim 39, wherein the radome includes a back face which is at least partially flush mounted to the front face of the antenna assembly.

41. The antenna device according to claim 40, wherein the back face is partially flush mounted to the front face of the antenna and there is at least one selected of the group of: a longitudinal groove, recess or a combination thereof, arranged at the back face of the radome which are configured to stop the surface wave propagation.

42. The antenna device according to claim 40, wherein the back face of the radome comprises at least one protrusion which at least partially engages the scattering elements at the font face of the antenna assembly in a mounted state.

43. The antenna device according to claim 39, wherein the radome comprises, in an area of the at least one antenna aperture, a dome-shaped lens such that incoming primary rays are focused with respect to the antenna aperture.

44. The antenna device according to claim 39, wherein the antenna assembly is on a back side at least partially covered by an absorbing material.
